(19) United States
(12) Patent Application Publication
(10) Pub. No.: US 2025/0194470 A1
(43) Pub. Date: Jun. 19, 2025

(54) METHOD TO PRODUCE SEEDS RAPIDLY THROUGH ASEXUAL PROPAGATION OF CUTTINGS IN LEGUMES

(71) Applicant: BENSON HILL COMPANY, St. Louis, MO (US)

(72) Inventors: Thomas RHANOR, Godfrey, IL (US); Jessica HO, St. Louis, MO (US); Lisa NEWMAN, Creve Coeur, MO (US); Edward FISCHER, Cottleville, MO (US); Tiffany TAYLOR, O'Fallen, IL (US)

(21) Appl. No.: 18/852,713

(22) PCT Filed: Mar. 30, 2023
(86) PCT No.: PCT/US2023/016889

§ 371 Date: Sep. 30, 2024

Related U.S. Application Data
(60) Provisional application No. 63/326,760, filed on Apr. 1, 2022.

(51) Int. Cl. A01G 2/10; A01G 22/40

(52) U.S. Cl. CPC A01G 2/10; A01G 22/40

(57) ABSTRACT

The present invention is directed at a method to produce a substantial number of seeds (e.g., 10,000) from a single plant. The method involves growing a mother plant under conditions designed to substantially maintain the mother plant in a vegetative state and substantially delay reaching reproductive stage. Then, removing the apical meristem once the mother plant has reached a desired stage of growth. The method further involves removing one or more branches from the mother plant (as branch cuttings). The method additionally involves maintaining each of the branch cuttings in growth media under acclimation conditions until each of the branch cuttings resume growing vegetatively as clone plants, then inducing the clone plants to flower and once the clone plants have been induced to flower, returning them to vegetative growth conditions. The clone plants are then maintained under vegetative growth conditions until they have produced a desired number of seeds.

### CROSS REFERENCE TO RELATED APPLICATION

This application claims the benefit and priority of U.S. Provisional Patent Application Ser. No. 63/326,760 filed Apr. 1, 2022 and entitled “Method to Produce Seeds Rapidly Through Asexual Propagation of Cuttings in Legumes,” the disclosure of which is hereby incorporated by reference in its entirety.

### BACKGROUND

Genomics has been used for decades to develop crops for our food system, but most agricultural companies have focused almost exclusively on increasing the yield of a few crops, resulting in commodity ingredients and a food system based on the quantity of calories available. While focus on quantity is important, that focus resulted in lower nutrient density and changed flavors. Minimal diversity in ingredient options also led food manufacturers to add costly water- and energy-intensive processing steps, and additives like sugar and salt to make up for attributes that were muted in crops over time.

However, consumers are now demanding food choices with simpler ingredients that benefit their health and the health of our planet. Food- and diet-related health issues, including obesity and diabetes, are some of the most widespread health issues today and continue to increase. More than 65% of American adults are either overweight or have obesity and, according to the Centers for Disease Control and Prevention, approximately 90% of Americans do not eat the recommended daily amount of fruits and vegetables. Americans spend more on diet-related illnesses than on food itself.

Moreover, the current food system has a substantial environmental impact on the planet. According to an April 2020 report entitled “Agriculture and climate change” prepared by Mckinsey & Company, twenty-seven percent of total greenhouse gas emissions (e.g., methane and nitrous oxide) are caused by agriculture, with cattle and dairy cows alone contributing eight gigatons of carbon dioxide equivalent (GtCO2e) emissions in 2019. (Accessed Dec. 22, 2021 at https://www.mckinsey.com/˜/media/mckinsey/industries/agriculture/our%20insights/reducing%20agriculture%20emissions%20through%20improved%20farming%20practices/agriculture-and-climate-change.pdf.)

At the same time, demand for plant-based solutions to feed the world and improve the environment is growing. Consumers are open to changing their eating habits to minimize further harm to the environment. Moreover, people are actively trying to incorporate more plant-based foods into their diets, especially protein alternatives found in the meat and dairy grocery store sections. NielsenIQ Sep. 9, 2021 article entitled “Growing demand for plant-based proteins” (Accessed Dec. 22, 2021 at https://nielseniq.com/global/en/insights/analysis/2021/examining-shopper-trends-in-plant-based-proteins-accelerating-growth-across-mainstream-channels/).

One potential large source of plant protein is from members of the legume family. Some important crops in the legume family include beans, soybeans, chickpeas, edamame, lentils, peanuts, and peas.

### Legumes: Generally

Legumes are members of the plant family Fabaceae and are distinguished by a unique type of fruit that develops from a simple carpel and generally opens on two sides. Most legumes species form a symbiotic relationship with nitrogen-fixing bacteria called Rhizobia. Nitrogen is an important element for all living organisms because nitrogen is a key component in the formation of amino acids and proteins.

Nitrogen constitutes nearly 70 percent of the atmosphere on Earth. However, despite nitrogen's ubiquity in our atmosphere, it is difficult for all plants and animals to biochemically access this nitrogen.

Atmospheric nitrogen, N₂, is inert, diatomic, and stable. Atmospheric nitrogen's chemical stability is due to a triple covalent bond between its individual nitrogen atoms. Humans must consume protein to obtain nitrogen, and most plants rely on fertilizer, or decomposing organic matter to meet their protein needs.

Legumes are different. The symbiotic relationship with Rhizobia bacteria allows legumes to access atmospheric nitrogen. The Rhizobia bacteria convert atmospheric N₂ into NH₃ and NH₄⁺, both of which plants are able to absorb and convert into amino acids. This symbiotic relationship between legumes and Rhizobia gives legumes and their seeds high levels of protein.

Due to their high protein content, legumes have been important agricultural crops for at least 5000 years and likely longer. Evidence of legume domestication spans the prehistoric globe: soy was likely first domesticated in ancient China, lentils were cultivated in ancient Egypt, peas were grown in early Mesopotamian civilizations. Today, legumes continue to be cultivated around the world and remain an important agricultural crop.

### Soybeans

Soy is the most cultivated legume. Soybeans are believed to have originated on the Asian Continent (Glycine soja) where it is believed they were also first domesticated in China (Glycine max). Abstract, Hymowitz and Newell, Taxonomy of the genus Glycine, domestication and uses of soybeans. Econ Bot 35, 272-288 (1981). Soybeans are a common field crop with the largest producing countries including the United States, Brazil, Argentina, China, India, Paraguay, and Canada. In the United States in 2020, soybeans were primarily produced in the Western Corn Belt (48.7%), Eastern Corn Belt (32.7%), and the Midsouth (11.9%) with Illinois and Iowa being the largest producing states. Naeve and Miller-Garvin, United States Soybean Quality 2020 Annual Report (Published by the University of Minnesota with the support of the United Soybean Board).

Soybean plants produce seed-bearing pods, each generally having 2-4 seeds. The seeds are harvested and processed either for future planting (i.e., to produce additional soybean plants) or processed into dozens of products (e.g., bean curd, feed for livestock, flour, meal, oil (cooking and industrial)). Soy flours includes flour concentrates and isolates, which are the primary protein products of soy.

Soybean seeds are usually planted in rows in soil. According to the 2012 Illinois Soybean Production Guide, soybeans require 55-60° F. soil temperature, an air temperature of at least 68° F., about 25 inches of water, sufficient nitrogen and five months from germination to harvest.

The radical (or root) is the first structure to emerge from a germinating soybean seed. The hypocotyl is the seedling structure that emerges from the soil surface. As the hypocotyl emerges it forms a crook as it pulls the cotyledons (i.e., the plant's first leaves) from the soil. Then, the cotyledons can unfold and begin the process of photosynthesis. Once the cotyledons have emerged from the soil surface the plant is said to be at the VE stage of vegetative development. The VC (cotyledon) development stage occurs once two unifoliate (or single blade) leaves emerge from opposite sides of the main stem and no longer touch the cotyledons. The VI (vegetative) development stage occurs once the first node (with a trifoliate leaf (i.e. three or four leaflets per leaf)) has formed above the unifoliate node. With the formation of each subsequent node “n” (n=2, 3 . . . ) with fully developed leaves the plant is referred to as being in the Vn development stage. Soybean farmers typically refer to the leaves and stems as the canopy.

The length of time for these vegetative and reproductive stages (discussed below) depends on the plant's maturity group (“MG” (i.e., the length of time from planting to physical maturity), the soil and air temperatures, and day length. Soybeans are short-day plants (i.e., the soybean plant is triggered to flower as the day length decreases below some critical value, which differs among MGs). See, e.g., Purcell, Salmeron and Ashlock, “Chapter 2: Soybean Growth and Development” Arkansas Soybean Production Handbook (University of Arkansas Division of Agricultural Research & Extension, 2014 Update). Soybeans planted in Arkansas tend to be MG3 through MG6. Id. In Illinois, where soybeans may be grown in regions traditionally understood to be in MG2 through MG5, the 2012 Illinois Soybean Production Guide notes that MG 5 to MG 8 soybeans tend to be determinate (i.e., they cease vegetative growth when the main stem terminates in a cluster of mature pods) and MG 0 to MG 4.9 tend to be indeterminate (i.e., they develop leaves and flowers simultaneously after flowering begins).

Each soybean plant can produce a lot of flowers. The flowers are small and hidden underneath the canopy of the plant. The number of flowers produced depends upon the number of nodes on the main stem and branches with flower-bearing nodes. Not all flowers produce pods. For those flowers that do produce pods whether the resulting pod produces a full complement of seeds requires ample nitrogen, sugar, other nutrients, and favorable environmental conditions.

When a soybean plant begins to flower, it is referred to as being in its reproductive (R) growth stage. Soybeans are a normally self-pollinating crop, in fact, they have a perfect flower structure for self-pollination. Still, bees have been known to be attracted to soybean flowers and cross-pollinated plants. Where cross-pollination is desired breeders need to intervene to prevent self-pollination: the pistil of a soybean plant can become mature and the anthers can begin to shed pollen before the soybean flowers even bloom, breeders seeking to cross-pollinate need to be proactive.

Soybean plants have eight reproductive stages: R1 (beginning flowering/bloom (i.e., at least one flower)), R2 (full flowering/bloom (i.e., an open flower at one of the two uppermost nodes)), R3 (beginning pod (i.e., a pod measuring 3/16 inch at one of the four uppermost nodes)), R4 (full pod (i.e., a pod measuring ¾ inch at one of the four uppermost nodes)), R5 (beginning seed (i.e., a seed measuring ⅛ inch long in the pod at one of the four uppermost nodes)), R6 (full seed (i.e., a pod containing a green seed that fills the pod at one of the four uppermost nodes)), R7 (beginning maturity (i.e., one normal pod has reached mature pod color)), and R8 (full maturity (i.e., at least 95% of pods have reach full mature color)).

As the days get shorter and the temperatures get cooler, the leaves on soybean plants begin to turn yellow, they subsequently turn brown, fall off, and expose the matured pods of soybeans. The soybeans are now ready to be harvested using combines. The header on the front of the combine cuts and collects the soybean plants. The combine separates the soybeans from their pods and stems and collects them into some container.

After harvesting, the soybeans are processed. The soybeans are cleaned, heat dried, crushed and then flaked. Thereafter, the flake is further processed. The primary method for further processing is referred to as the extraction or solvent process, as it uses organic solvents (e.g. hexane) to recover the soybean oil and protein from the flake. Aside from its substantial use of solvents, this process consumes significant amounts of energy.

### Yellow Pea

Yellow pea is another agriculturally important legume and is cultivated around the planet. Yellow pea is ranked fourth in terms of world production of legumes. Yellow pea is self-pollinating and generally are planted in spring when soil temperatures are above 40 degrees Fahrenheit. Emergence normally occurs 10-14 days after planting. Pea roots generally grow about to a depth of two feet, but may grow up to four. Older pea pods mature first. Pea pods are mature when all pods turn yellow or tan in color. This process occurs faster when temperatures are hotter. A rising temperature may decrease the number of pods and seeds produced. Yellow peas are harvested as soon as the seed is hard, generally in late July.

Protein is extracted from the pea by first drying, cleaning and spitting the peas. Next, protein is either extracted using a wet fractionation or a dry fractionation method. A wet fractionation involves immersion in a low pH solution to precipitate protein out of the pea. A dry fractionation method involves a milling and air classification to separate protein rich fragments out from higher starch content fragments.

### Seed Varieties, Breeding, and Genetic Modification

Today, there are literally thousands of varieties of legumes. These cell lines are the result of hundreds of years of selective breeding. Selective breeding is the process of selectively propagating plants with more desired traits (often called “phenotypes”) and eliminating plants with less desired phenotypes. Breeding generations are often designed F1, F2, etc, (wherein the “F” stands for “filial”). It may further involve crossing two plants to produce one or more new varieties.

Plant botanists have understood since the days of Gregor Mendel, that plants may exhibit dominant or recessive phenotypes/traits (e.g., seed shape, flower color, seed coat tint, pod shape, unripe pod color, flower location, and plant height). Through his experiments on pea plants, Mendel further taught that the genotype of a particular phenotype is not necessarily correlated because that phenotype may result from homozygous dominant, heterozygous, or homozygous recessive alleles. Where the phenotype is dominant, it will be exhibited by either of the first two zygosities. Whereas a recessive phenotype can only be exhibited by the third, homozygous recessive example.

Homozygous genotypes breed true from generation to generation, while heterozygous genotypes do not. Thus, after finding a desirable phenotype, plant breeders work to develop homozygosity in the population, and then release the resulting pure line as a new variety. For example, hybrid varieties are the result of crossing two homozygous, but unrelated pure lines of a species. The resulting F1 of the cross are all heterozygous. However, by F2 50% of the plants are either homozygous (dominant or recessive) and by F3 heterozygosity is reduced to 25%. Once a desired trait is found in homozygous plants, commercial quantities are produced by replanting the resulting seeds over several generations.

When an individual plant or a subset of plants in a breeding program is identified as having a potentially desirable phenotypic trait, researchers will need a large quantity of seeds from that plant to determine whether the observed desirable trait is homozygous. This means a successful plant breeding program requires thousands of seeds from a single plant or plant line to verify zygosity and phenotypic characteristics.

Growing thousands of plants from a small subset of sample, and especially from a single plant, is time and resource intensive. For example, a typical soy plant can produce approximately 150-300 seeds under field conditions in approximately 120 days. Yellow pea, on the other hand, can only produce approximately 100-150 seeds during a generally similar period to soy (i.e., approximately 80-100 days). This growth cycle process can be further hindered by seasonal limitations. Soy, yellow pea and other legumes can only be grown during a portion of the year outdoors. While some breeding programs can make use of indoor growing facilities and theoretically cultivate a desirable cell line throughout the year, these facilities are costly, and their use comes with the large opportunity cost of not breeding other potentially desirable cell lines.

Thus, plant breeding programs seeking to replicate a single donor, or mother plant, are limited by the number of seeds a single plant can produce, how fast that individual plant can produce them, and how long a growing season lasts. There remains a need in plant breeding programs to increase the number of seeds an individual plant with desirable traits can produce and to produce those seeds at a faster rate than is currently possible.

### SUMMARY OF THE DISCLOSURE

The present disclosure is directed to methods of producing a substantial number of seeds (e.g., 10,000) from a single mother plant, which may preferably be from the legume family. The mother plant has an apical meristem and may be in one or both of a vegetative state and reproductive state, the vegetative state having vegetative stages and the reproductive state having reproductive stages.

One preferred method comprises (a) growing the mother plant under conditions designed to substantially maintain the mother plant in a vegetative state and substantially delay reaching reproductive stage; (b) removing the apical meristem from the mother plant once the mother plant has reached a desired stage of growth; (c) removing one or more branches from the mother plant as one or more branch cuttings wherein the one or more branches were sufficiently developed on the mother plant following the removal of the apical meristem; (d) maintaining each of the one or more branch cuttings in growth media under acclimation conditions until each of the branch cuttings resume growing vegetatively as clone plants; (e) inducing the clone plants to flower; (f) once the clone plants have been induced to flower, returning the clone plants to vegetative growth conditions; and (g) maintaining the clone plants under vegetative growth conditions until they have produced a desired number of seeds. An additional step of moving the plants into short-day growing conditions to finish producing seeds may be utilized depending on the particular plant species (e.g., soybean, cowpea, pigeonpea, common bean) and desired timeline (e.g., 30 days before the intended end date).

In some embodiments, where the mother plant is a short-day plant, the conditions to substantially maintain the mother plant in a vegetative state and substantially delay reaching reproductive stage may comprise applying long-day conditions to the mother plant.

In some embodiments, the desired level of growth may be determined by assessing at least one of the vegetative and reproductive stages of the mother plant to determine whether the mother plant has progressed enough to remove the apical meristem.

In some embodiments, the method may further comprise exposing one or more branch cuttings to an auxin solution before maintaining the branch cuttings in the growth media.

In some embodiments, the branch cuttings may be exposed to the auxin solution by applying the auxin solution to the branch cutting by brushing on, dripping on, pouring on, or spraying on and placing the branch cutting in a container with the auxin solution.

In some embodiments, the auxin solution includes auxin, nutrients, and PH balanced water solution.

In some embodiments, maintaining the branch cuttings in growth media under acclimation conditions until the branch cutting resumes growing vegetatively may further comprise exposing the branch cuttings to high relative humidity and vegetative growing conditions.

In some embodiments, the method further may comprise exposing the growth media to an auxin solution prior to the growth media receiving the branch cuttings.

In some embodiments, the method may further comprise maintaining the apical meristem cutting in a growth media under acclimation conditions until the apical meristem cutting begins growing vegetatively.

In some embodiments, the method may further comprise exposing the apical meristem cutting to an auxin solution.

In some embodiments, the method may further comprise maintaining the apical meristem cutting in growth media under acclimation conditions until the apical meristem cutting resumes growing vegetatively further comprises exposing the apical meristem cutting to high relative humidity and vegetative growing conditions.

These and other aspects of the disclosure will be further explained below.

### DRAWINGS

FIG. 1 illustrates the overall process (100) described more fully herein.

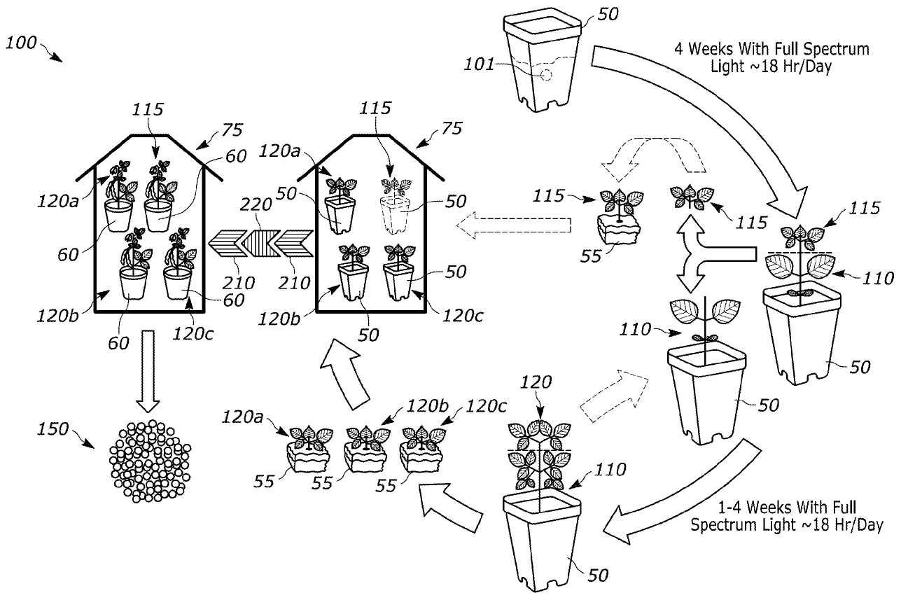

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. The following detailed description is, therefore, not to be taken in a limiting sense.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including, but not limited to, each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

As used herein, a “mutation” is any change in a nucleic acid sequence. Nonlimiting examples comprise insertions, deletions, duplications, substitutions, inversions, and translocations of any nucleic acid sequence, regardless of how the mutation is brought about and regardless of how or whether the mutation alters the functions or interactions of the nucleic acid. For example and without limitation, a mutation may produce altered enzymatic activity of a ribozyme, altered base pairing between nucleic acids (e.g. RNA interference interactions, DNA-RNA binding, etc.), altered mRNA folding stability, and/or how a nucleic acid interacts with polypeptides (e.g. DNA-transcription factor interactions, RNA-ribosome interactions, gRNA-endonuclease reactions, etc.). A mutation might result in the production of proteins with altered amino acid sequences (e.g. missense mutations, nonsense mutations, frameshift mutations, etc.) and/or the production of proteins with the same amino acid sequence (e.g. silent mutations). Certain synonymous mutations may create no observed change in the plant while others that encode for an identical protein sequence nevertheless result in an altered plant phenotype (e.g. due to codon usage bias, altered secondary protein structures, etc.). Mutations may occur within coding regions (e.g., open reading frames) or outside of coding regions (e.g., within promoters, terminators, untranslated elements, or enhancers), and may affect, for example and without limitation, gene expression levels, gene expression profiles, protein sequences, and/or sequences encoding RNA elements such as tRNAs, ribozymes, ribosome components, and microRNAs.

Methods disclosed herein are not limited to mutations made in the genomic DNA of the plant nucleus. For example, in certain embodiments a mutation is created in the genomic DNA of an organelle (e.g. a plastid and/or a mitochondrion). In certain embodiments, a mutation is created in extrachromosomal nucleic acids (including RNA) of the plant, cell, or organelle of a plant. Nonlimiting examples include creating mutations in supernumerary chromosomes (e.g. B chromosomes), plasmids, and/or vector constructs used to deliver nucleic acids to a plant. It is anticipated that new nucleic acid forms will be developed and yet fall within the scope of the claimed invention when used with the teachings described herein.

Methods disclosed herein are not limited to certain techniques of mutagenesis. Any method of creating a change in a nucleic acid of a plant can be used in conjunction with the disclosed invention, including the use of chemical mutagens (e.g. methanesulfonate, sodium azide, aminopurine, etc.), genome/gene editing techniques (e.g. CRISPR-like technologies, TALENs, zinc finger nucleases, and meganucleases), ionizing radiation (e.g. ultraviolet and/or gamma rays) temperature alterations, long-term seed storage, tissue culture conditions, targeting induced local lesions in a genome, sequence-targeted and/or random recombinases, etc. It is anticipated that new methods of creating a mutation in a nucleic acid of a plant will be developed and yet fall within the scope of the claimed invention when used with the teachings described herein.

Similarly, the embodiments disclosed herein are not limited to certain methods of introducing nucleic acids into a plant and are not limited to certain forms or structures that the introduced nucleic acids take. Any method of transforming a cell of a plant described herein with nucleic acids are also incorporated into the teachings of this innovation, and one of ordinary skill in the art will realize that the use of particle bombardment (e.g. using a gene-gun), Agrobacterium infection and/or infection by other bacterial species capable of transferring DNA into plants (e.g., Ochrobactrum sp., Ensifer sp., Rhizobium sp.), viral infection, and other techniques can be used to deliver nucleic acid sequences into a plant described herein. Methods disclosed herein are not limited to any size of nucleic acid sequences that are introduced, and thus one could introduce a nucleic acid comprising a single nucleotide (e.g. an insertion) into a nucleic acid of the plant and still be within the teachings described herein. Nucleic acids introduced in substantially any useful form, for example, on supernumerary chromosomes (e.g. B chromosomes), plasmids, vector constructs, additional genomic chromosomes (e.g. substitution lines), and other forms is also anticipated. It is envisioned that new methods of introducing nucleic acids into plants and new forms or structures of nucleic acids will be discovered and yet fall within the scope of the claimed invention when used with the teachings described herein.

Methods disclosed herein include conferring desired traits to plants, for example, by mutating sequences of a plant, introducing nucleic acids into plants, using plant breeding techniques and various crossing schemes, etc. These methods are not limited as to certain mechanisms of how the plant exhibits and/or expresses the desired trait. In certain nonlimiting embodiments, the trait is conferred to the plant by introducing a nucleotide sequence (e.g. using plant transformation methods) that encodes production of a certain protein by the plant. In certain nonlimiting embodiments, the desired trait is conferred to a plant by causing a null mutation in the plant's genome (e.g. when the desired trait is reduced expression or no expression of a certain trait). In certain nonlimiting embodiments, the desired trait is conferred to a plant by crossing two plants to create offspring that express the desired trait. It is expected that users of these teachings will employ a broad range of techniques and mechanisms known to bring about the expression of a desired trait in a plant. Thus, as used herein, conferring a desired trait to a plant is meant to include any process that causes a plant to exhibit a desired trait, regardless of the specific techniques employed.

As used herein, “fertilization” and/or “crossing” broadly includes bringing the genomes of gametes together to form zygotes but also broadly may include pollination, syngamy, fecundation and other processes related to sexual reproduction. Typically, a cross and/or fertilization occurs after pollen is transferred from one flower to another, but those of ordinary skill in the art will understand that plant breeders can leverage their understanding of fertilization and the overlapping steps of crossing, pollination, syngamy, and fecundation to circumvent certain steps of the plant life cycle and yet achieve equivalent outcomes, for example, a plant or cell of a soybean cultivar described herein. In certain embodiments, a user of this innovation can generate a plant of the claimed invention by removing a genome from its host gamete cell before syngamy and inserting it into the nucleus of another cell. While this variation avoids the unnecessary steps of pollination and syngamy and produces a cell that may not satisfy certain definitions of a zygote, the process falls within the definition of fertilization and/or crossing as used herein when performed in conjunction with these teachings. In certain embodiments, the gametes are not different cell types (i.e. egg vs. sperm), but rather the same type and techniques are used to effect the combination of their genomes into a regenerable cell. Other embodiments of fertilization and/or crossing include circumstances where the gametes originate from the same parent plant, i.e. a “self” or “self-fertilization”. While selfing a plant does not require the transfer pollen from one plant to another, those of skill in the art will recognize that it nevertheless serves as an example of a cross, just as it serves as a type of fertilization. Thus, methods and compositions taught herein are not limited to certain techniques or steps that must be performed to create a plant or an offspring plant of the claimed invention, but rather include broadly any method that is substantially the same and/or results in compositions of the claimed invention.

A plant refers to a whole plant, any part thereof, or a cell or tissue culture derived from a plant, comprising any of: whole plants, plant components or organs (e.g., leaves, stems, roots, etc.), plant tissues, seeds, plant cells, protoplasts and/or progeny of the same. A plant cell is a biological cell of a plant, taken from a plant or derived through culture of a cell taken from a plant.

A population means a set comprising any number, including one, of individuals, objects, or data from which samples are taken for evaluation, e.g. estimating QTL effects and/or disease tolerance. Most commonly, the terms relate to a breeding population of plants from which members are selected and crossed to produce progeny in a breeding program. A population of plants can include the progeny of a single breeding cross or a plurality of breeding crosses and can be either actual plants or plant derived material, or in silico representations of plants. The member of a population need not be identical to the population members selected for use in subsequent cycles of analyses nor does it need to be identical to those population members ultimately selected to obtain a final progeny of plants. Often, a plant population is derived from a single biparental cross but can also derive from two or more crosses between the same or different parents. Although a population of plants can comprise any number of individuals, those of skill in the art will recognize that plant breeders commonly use population sizes ranging from one or two hundred individuals to several thousand, and that the highest performing 5-20% of a population is what is commonly selected to be used in subsequent crosses in order to improve the performance of subsequent generations of the population in a plant breeding program.

Crop performance is used synonymously with plant performance and refers to how well a plant grows under a set of environmental conditions and cultivation practices. Crop performance can be measured by any metric a user associates with a crop's productivity (e.g. yield), appearance and/or robustness (e.g. color, morphology, height, biomass, maturation rate), product quality (e.g. fiber lint percent, fiber quality, seed protein content, seed carbohydrate content, etc.), cost of goods sold (e.g. the cost of creating a seed, plant, or plant product in a commercial, research, or industrial setting) and/or a plant's tolerance to disease (e.g. a response associated with deliberate or spontaneous infection by a pathogen) and/or environmental stress (e.g. drought, flooding, low nitrogen or other soil nutrients, wind, hail, temperature, day length, etc.). Crop performance can also be measured by determining a crop's commercial value and/or by determining the likelihood that a particular inbred, hybrid, or variety will become a commercial product, and/or by determining the likelihood that the offspring of an inbred, hybrid, or variety will become a commercial product. Crop performance can be a quantity (e.g. the volume or weight of seed or other plant product measured in liters or grams) or some other metric assigned to some aspect of a plant that can be represented on a scale (e.g. assigning a 1-10 value to a plant based on its disease tolerance).

A microbe will be understood to be a microorganism, i.e. a microscopic organism, which can be single celled or multicellular. Microorganisms are very diverse and include all the bacteria, archaea, protozoa, fungi, and algae, especially cells of plant pathogens and/or plant symbionts. Certain animals are also considered microbes, e.g. rotifers. In various embodiments, a microbe can be any of several different microscopic stages of a plant or animal. Microbes also include viruses, viroids, and prions, especially those which are pathogens or symbionts to crop plants.

A fungus includes any cell or tissue derived from a fungus, for example whole fungus, fungus components, organs, spores, hyphae, mycelium, and/or progeny of the same. A fungus cell is a biological cell of a fungus, taken from a fungus or derived through culture of a cell taken from a fungus.

A pest is any organism that can affect the performance of a plant in an undesirable way. Common pests include microbes, animals (e.g. insects and other herbivores), and/or plants (e.g. weeds). Thus, a pesticide is any substance that reduces the survivability and/or reproduction of a pest, e.g. fungicides, bactericides, insecticides, herbicides, and other toxins.

Tolerance or improved tolerance in a plant to disease conditions (e.g. growing in the presence of a pest) will be understood to mean an indication that the plant is less affected by the presence of pests and/or disease conditions with respect to yield, survivability and/or other relevant agronomic measures, compared to a less tolerant, more “susceptible” plant. Tolerance is a relative term, indicating that a “tolerant” plant survives and/or performs better in the presence of pests and/or disease conditions compared to other (less tolerant) plants (e.g., a different soybean cultivar) grown in similar circumstances. As used in the art, tolerance is sometimes used interchangeably with “resistance”, although resistance is sometimes used to indicate that a plant appears maximally tolerant to, or unaffected by, the presence of disease conditions. Plant breeders of ordinary skill in the art will appreciate that plant tolerance levels vary widely, often representing a spectrum of more-tolerant or less-tolerant phenotypes, and are thus trained to determine the relative tolerance of different plants, plant lines or plant families and recognize the phenotypic gradations of tolerance.

A plant, or its environment, can be contacted with a wide variety of “agriculture treatment agents.” As used herein, an “agriculture treatment agent”, or “treatment agent”, or “agent” can refer to any exogenously provided compound that can be brought into contact with a plant tissue (e.g. a seed) or its environment that affects a plant's growth, development and/or performance, including agents that affect other organisms in the plant's environment when those effects subsequently alter a plant's performance, growth, and/or development (e.g. an insecticide that kills plant pathogens in the plant's environment, thereby improving the ability of the plant to tolerate the insect's presence). Agriculture treatment agents also include a broad range of chemicals and/or biological substances that are applied to seeds, in which case they are commonly referred to as seed treatments and/or seed dressings. Seed treatments are commonly applied as either a dry formulation or a wet slurry or liquid formulation prior to planting and, as used herein, generally include any agriculture treatment agent including growth regulators, micronutrients, nitrogen-fixing microbes, and/or inoculants. Agriculture treatment agents include pesticides (e.g. fungicides, insecticides, bactericides, etc.) hormones (abscisic acids, auxins, cytokinins, gibberellins, etc.) herbicides (e.g. glyphosate, atrazine, 2,4-D, dicamba, etc.), nutrients (e.g. a plant fertilizer), and/or a broad range of biological agents, for example a seed treatment inoculant comprising a microbe that improves crop performance, e.g. by promoting germination and/or root development. In certain embodiments, the agriculture treatment agent acts extracellularly within the plant tissue, such as interacting with receptors on the outer cell surface. In some embodiments, the agriculture treatment agent enters cells within the plant tissue. In certain embodiments, the agriculture treatment agent remains on the surface of the plant and/or the soil near the plant. In certain embodiments, the agriculture treatment agent is contained within a liquid. Such liquids include, but are not limited to, solutions, suspensions, emulsions, and colloidal dispersions. In some embodiments, liquids described herein will be of an aqueous nature. However, in various embodiments, such aqueous liquids that comprise water can also comprise water insoluble components, can comprise an insoluble component that is made soluble in water by addition of a surfactant, or can comprise any combination of soluble components and surfactants. In certain embodiments, the application of the agriculture treatment agent is controlled by encapsulating the agent within a coating, or capsule (e.g. microencapsulation). In certain embodiments, the agriculture treatment agent comprises a nanoparticle and/or the application of the agriculture treatment agent comprises the use of nanotechnology.

In certain embodiments, plants disclosed herein can be modified to exhibit at least one desired trait, and/or combinations thereof. The disclosed innovations are not limited to any set of traits that can be considered desirable, but nonlimiting examples include male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, modified water use efficiency, and/or combinations thereof. Desired traits can also include traits that are deleterious to plant performance, for example, when a researcher desires that a plant exhibits such a trait in order to study its effects on plant performance.

In certain embodiments, a user can combine the teachings herein with high-density molecular marker profiles spanning substantially the entire soybean genome to estimate the value of selecting certain candidates in a breeding program in a process commonly known as genomic selection.

To produce a larger-than-typically-observed number of seeds for a plant breeding program in a manner faster than is conventionally possible, a method of asexually propagating cuttings from a single mother plant is utilized. Each step of the method is described below and illustrated in the FIGURE.

Selection. As noted above, large scale breeding programs require thousands of plants and thousands of seeds to identify plants with desired phenotypic traits. This method may be used with several plants from the same germline, a single plant with a desirable trait, or more broadly, to produce a higher number of desirable seeds than is conventionally possible.

Mother Plant Growth. A mother plant is grown from a seed. As the FIGURE illustrates, the seed (101) is preferably placed in a 2.5-inch pot (50) filled with Berger BM2® germination soil (distributed by Berger, Saint-Modeste, Quebec, Canada). Other pot sizes may be used with the understanding smaller pots will likely restrict the mother plant's root development and larger pots are likely to waste space, which may be particularly significant where indoor growing spaces are utilized.

The mother plant is grown in vegetative conditions. As depicted by the FIGURE, vegetative conditions for a short-day crop, such as soybean, are more than 14 hours of at least 900 μmol/m²/second (and more preferably 1000 μmol/m²/second) of light per 24-hour period, and preferably 18 hours of light. All light intensities referred to herein are measured at 32 inches from floor, which is the approximate height of base of plant. The light source preferably produces a full spectrum of light. In short-day crops, long-day growing conditions are used to induce branching and inhibit flowering and seed production. Short-day growing conditions may be applied to day-neutral and long-day plants to delay reproductive development. Alternatively, the use of warmer growing conditions for cool-season crops may be used to delay reproductive development. Preferably, the initial growth happens for approximately four weeks. An initial growth period of more or less than approximately four weeks is also possible. A shorter period is more likely to result in an immature root network development, which in turn, may not support future cutting(s) from that particular mother plant. With respect to a longer growth period, the additional time spent in this “mother plant growth” phase will increase the total time to produce the seeds, thereby lessening the utility of the presently disclosed methods.

Meristem Removal. Once the mother plant (110) is sufficiently established (based on the consideration set forth above), the apical meristem shoot (depicted in the FIGURE as 115) is removed to induce branching in the mother plant (110). This removal is preferably accomplished by cutting using a scissors, garden shears, knife, or other cutting tool. It is alternatively possible to break the meristem (115) off the plant (110) at the desired location. All these alternatives shall be collectively referred to as “removing” or “removal” in the present disclosure. The apical meristem shoot (115) may be removed anywhere below the top node meristem (also known as the first axial meristem) and above the first (lowest) node. Removal above the top node meristem would result in a nonviable clone and branching in the mother plant would not be induced. Alternatively, removing the meristem below the top node would reduce the number of possible branches produced by the mother plant and, thus, reduce the potential number of clones that will be produced in the first cycle. Thus, the meristem removal preferably occurs below the top node meristem and within the top two inches of the meristem shoot and above the first node of the mother plant.

Subsequent Growth. As illustrated in the FIGURE, following the apical meristem removal, the mother plant (110) continues to be grown in long day conditions to allow for the formation and development of one or more new branches (120) on the stem of the mother plant (110). The longer the mother plant (110) is grown after removal of the apical meristem (115), the greater number of new branches (120) that will form and develop which would ultimately provide for a greater number of total seeds that may be produced from this single mother plant (110). Thus, if a smaller number of seeds is desired, the mother plant only needs to be grown for a relatively short period. If a higher number of seeds is desired, the mother plant will be grown for a relatively longer period. Preferably, this subsequent growth of the mother plant lasts for approximately one to four weeks.

The number of seeds that are desired to be produced will determine the number of desired clones to propagate. One of ordinary skill in the art knows that a given plant is expected produce a generally known approximate number of seeds. In this manner, one of ordinary skill in the art will be able to determine how many clones to propagate. Propagation may occur when a mother plant has between two and eight nodes, with five nodes being preferred.

Branch Removal and Clone Creation. After the subsequent branches (120a, 120b, 120c) have developed on the mother plant (110), portions of each branch may be removed, placed in a growth media (55) and given an auxin/nutrients solution to induce root growth. Alternatively, the branches (120a, 120b, 120c) may be removed from the mother plant (110) and placed into hydroponics or aeroponics to induce rooting without the use of a growing media (55). Choice of cuttings is determined by several factors: a minimum of two nodes, one with newly forming leaf bud and one node below with fully open trifoliate leaf, and large enough to keep a portion of stem below the bottom node for sticking into the growth media for rooting. The growth media is preferably Grodan® A-OK Starter Plug™ manufactured by ROCKWOOL® International A/S of Milton, Ontario, Canada, but other growth media may be used. The auxin solution preferably comprises liquid Hormex® Rooting Hormone Concentrate & Vitamin B1 (distributed by Maia Products, Inc. of Westlake Village, CA) and Clonex® nutrient solution (distributed by Hydrodynamics International of Lansing, Michigan). Other products may be used such as, but not limited to, powder-form Hormex®, Garden Safe Brand®, Bonide Root N Grow Stimulator®, or Hormodin® Rooting Compound.

As illustrated in the FIGURE, this same post-removing treatment may be optionally applied to the original apical meristem cutting (115) when it is cut from the mother plant (110). In such a case the apical meristem (115) is preferably dipped in the auxin solution before being placed in the growing media (55) to encourage quick root growth in the clone. Thereafter, the clone would be treated as any other clone taken from the mother plant. By practicing this optional step, the method will produce another clone of the mother plant, thus increasing the number of seeds produced. Moreover, the apical meristem-based clone (115) could be used to produce seeds 1-4 weeks ahead of the branches (120) subsequently produced by the mother plant. The apical meristem-based clone (115) can alternatively be kept in vegetative conditions to use a secondary mother plant which can produce additional clones at the same approximate time as when second lateral clones are taken from the original mother plant (110). In this way, the apical meristem-based clone (115) can serve as a second mother plant, which reduces the risk of losing the source of the clones (and therefore any beneficial plant genetics associated with those plants).

Each clone (120a, 120b, and 120c) is placed within the growth media (55) in acclimation conditions until the cut branch/meristem roots and begins growing vegetatively. Acclimation conditions are low levels of light for preferably 7 to 14 days until roots become visible and new trifoliate leaves first appear. Acclimation conditions are preferrable because the new clones are vulnerable and over exposure to light could result in plant death.

In this manner, the removed cuttings (120a-c and optionally, 115) become clones of the mother plant (110). The cloned plant is propagated asexually, and therefore will have the same DNA, and therefore the same genotype as its parent, in this case, the mother plant. In other words, the mother plant's DNA will be present in any seeds produced by the clonal plants. More cuttings may be removed from the mother plant to produce additional clones. However, as illustrated in the FIGURE, it may be beneficial to remove fewer cuttings at a time to increase the chances that the mother plant will survive to produce additional future sets of cuttings.

Clone Vegetative Growth. All the clones (apical meristem shoot 115 and subsequent cuttings 120a-c) in their respective growing media may be preferably placed in a 1020 tray with adjustable humidity dome attached over the tops of the clones to retain high relative humidity and placed within a growth chamber or growing room (75). 1020 trays are preferably used due to their availability and low cost, but other growing trays can be used. These 1020 trays may or may not have holes. As the growing media was watered before the cuttings 120/115 were inserted therein, it is generally not necessary to water the growing media after cutting insertion where the plants are maintained under a covered tray, as the dome retains the moisture resulting in humidity as high as approximately 90%.

Once the clones have sufficiently grown, they are transferred to one-gallon pots (60) to further facilitate growth. These clones are then placed into acclimation conditions with increasing light intensity and lower relative humidity, over the course of 3-7 days through the use of shade cloths or placement in shaded areas under benches. It is possible to lengthen the time of acclimation, but this would delay the timeline of the overall process. Growing media, preferably Berger BM2, is pre-moistened with fertilized water, preferably reverse-osmosis water with Jack's Professional LX® 15-5-15 fertilizer (distributed by JR Peters, Inc., Allentown, Pennsylvania) at 150 ppm N or an equivalent type of fertilizer water, maintained at a pH of 5.5-6.5, preferably 5.9. When growing media dries and roots have grown to bottom, additional water is added to re-wet the media. The watering of these plants will increase in amount and frequency as the plant grows and matures.

Long Day Growth. As illustrated in the FIGURE, the clones 120/115 continue to grow in the growth chamber (75), where they are initially exposed to long-day conditions (210) (i.e., exposure to at least 14 (preferably even 18) hours of at least 700 (and more preferably 1000) μmol/m²/second of full spectrum light per 24-hour period). This exposure to long day conditions (210) lasts for approximately 1-4 weeks until the clones have sufficiently grown. In this context, “sufficiently grown” means that a clone has preferably added 2 or more new nodes with trifoliate leaves, and more preferably 5 new nodes with trifoliate leaves, but as many as 8, above the initial node that was cut.

Short Day Growth. For photosensitive short-day plants (such as soybeans), after each clone (120/115) has sufficiently grown, it is exposed to a short-day growth light treatment (220) for approximately 7-21 days and preferably for at least approximately 10-15 days to induce flowering. Less than 10 days of exposure is possible, but it is likely that flowers and seeds will be not mature on time to reach target timelines. More than 15 days of exposure will lengthen the overall process, thereby decreasing its utility. Short day growth conditions are less than 14 hours a day of 900 μmol/m²/second of full spectrum light per 24-hour period.

Where a plant is photo-insensitive (such as yellow pea), exposure to short day growth condition is unnecessary. Instead, for photo-insensitive plants, the light exposure may be increased to up to approximately 23 hours per day until plants have reached a desired maturity. However, in certain circumstances, it may be beneficial to grow photo-insensitive crops under short-day conditions to extend their vegetative period. It may also be beneficial to grow crops under conditions that are opposite to their ideal reproductive environment, such as warmer temperatures for cool temperature crops and cool temperatures for warm temperature crops. So, essentially, the conditions that are conducive to flowering and seed setting are to be avoided when inducing extended vegetation. The daylength and the number of days at the altered conditions should be chosen to maximize the number of clones without causing a delay in overall growth or a delay in the overall timeline for the crop cycle that would prevent reaching the target total timeline.

Subsequent Long Day Growth. After photo-sensitive clones 120/115 have been exposed to short day conditions, they may be transplanted into larger growing media and again subjected to long-day conditions (210), long enough for each clone to produce the desired number of seeds and those seeds are ready to be harvested. The desired number of seeds will depend on the particular needs.

Seed Collection. As illustrated in the FIGURE, seeds (150) are collected from the clones. A typical lone soy plant is capable of producing approximately 300-600 seeds in 120 days. Whereas a typical lone yellow pea plant is capable of producing approximately 150-300 seeds in approximately 110 days. Utilizing method 100, a single soybean plant may produce approximately 9,000 or more seeds in just 160 days. Similarly, utilizing method 100, a single yellow pea plant may produce approximately 4000 or more seeds.

Examples. The present invention is illustrated in further detail with reference to the following non-limiting examples.

### Example 1—Base Protocol for Soybean

Researchers developed a “Base Protocol” to produce a larger-than-average number of seeds from a single Mother Plant. This Base Protocol is described in Example 1, and was used by researchers for Examples 1-8. The Base Protocol is preferably used to produce a larger-than-average number of seeds in soy plants. Any deviations from the Base Protocol in subsequent examples are noted.

A single soybean mother plant was grown from a seed in a 2.5-inch pot containing Berger BM2® germination soil (distributed by Berger, Saint-Modeste, Quebec, Canada). The mother plant was grown in long day conditions of 18 hours per 24-hour period of 1000 μmol/m²/second full spectrum light for four weeks. (Unless otherwise stated all light intensity measurements were taken proximate the canopy of the plant.) After four weeks, the apical meristem of the mother plant was removed. The removing process occurred below the meristem within the top two inches of the meristem shoot and above the first node. The cut meristem was dipped into liquid Hormex® Rooting Hormone Concentrate & Vitamin B1 (distributed by Maia Products, Inc. of Westlake Village, CA).

The meristem was then placed into a grow plug, which comprised a Grodan® A-OK Starter Plug™ ROCKWOOL® growing media that had previously been placed in an auxin solution for approximately 5 minutes. That auxin solution was comprised of liquid Hormex® Rooting Hormone Concentrate & Vitamin B1 and Clonex nutrient solution (distributed by Hydrodynamics International of Lansing, Michigan) was formulated by first mixing 65 mL of Clonex® and 15 mL of Hormex® with 13 L water, then adjusting the pH to between 5.5-5.9, using about two drops of pH down solution introduced using a 1 mL pipette. The meristem in the growing media was exposed to acclimation conditions of greater than 14 hours of 900 μmol/m²/second light for 7-14 days.

Following the meristem removal, the mother plant was transferred to a one-gallon pot to further facilitate growth and grown in long day conditions of more than 14 hours a day of 900 μmol/m²/second light for two to four weeks. After four weeks of growth, additional cuttings were removed from the mother plant and placed in growing media dipped in the auxin solution in the same manner as the meristem and then exposed to the same acclimation conditions as the meristem.

Cuttings from the mother plant were placed in 1020 trays with domes to maintain humidity levels of 90%. The 1020 trays were watered before planting. The clones were exposed to 14 days of short-day conditions of less than 14 hours a day of 900 μmol/m²/second of full spectrum light. Following 14 days of short-day conditions to induce flowering, plants were exposed to long day conditions of more than 14 hours a day of 900 μmol/m²s light. Following long-day exposure for a sufficient number of weeks (and up to 10 weeks), seeds were harvested.

Example One progressed along the following timeline, referred to herein as the “Base Protocol”:

TABLE 1

| Day | Treatment | Action |
|---|---|---|
| 0 | Day: 18 hour light (1000 μmol/m² full spectrum), | Plant seed for Mother Plant |
| | 29° C., 65% relative humidity | into 2.5 inch pots with soil |
| | Night: 6 hour dark, 19° C., 70% relative humidity | |
| 21 | Day: 18 hour light (1000 μmol/m² full spectrum), | Transplant Mother Plant into 1 |
| | 29° C., 65% relative humidity | gallon pot |
| | Night: 6 hour dark, 19° C., 70% relative humidity | |
| 28 | Day: 18 hour light (1000 μmol/m² full spectrum), | Cut apical meristem above |
| | 29° C., 65% relative humidity | first node, place cutting into |
| | Night: 6 hour dark, 19° C., 70% relative humidity | grow plug. |
| 42 | Day: 18 hour light (1000 μmol/m² full spectrum), | Cut first lateral clones from |
| | 29° C., 65% relative humidity | the mother plant and place into |
| | Night: 6 hour dark, 19° C., 70% relative humidity | grow plug (approximately 10 |
| | | clones) |
| 42 | Day: 18 hour light (1000 μmol/m² full spectrum), | Transplant apical clones into 1 |
| | 29° C., 65% relative humidity | gallon pots |
| | Night: 6 hour dark, 19° C., 70% relative humidity | |
| 56 | Day: 18 hour light (1000 μmol/m² full spectrum), | Cut second lateral clones from |
| | 29° C., 65% relative humidity | mother plant and place into |
| | Night: 6 hour dark, 19° C., 70% relative humidity | grow plug (approximately 20 |
| | | clones) |
| 56 | Day: 18 hour light (1000 μmol/m² full spectrum), | Transplant first lateral clones |
| | 29° C., 65% relative humidity | into 1 gallon pot |
| | Night: 6 hour dark, 19° C., 70% relative humidity | |
| 56-63 | Day: 12 hour light (1000 μmol/m² full spectrum), | Move apical clones to short |
| | 29° C., 65% relative humidity | day environment when 5 new |
| | Night: 12 hour dark, 19° C., 70% relative humidity | nodes are identified above the |
| | | first node on the clone (i.e. the |
| | | original node). |
| 70 | Day: 18 hour light (1000 μmol/m² full spectrum), | Transplant second lateral |
| | 29° C., 65% relative humidity | clones into 1 gallon pots |
| | Night: 6 hour dark, 19° C., 70% relative humidity | |
| 70-77 | Day: 12 hour light (1000 μmol/m² full spectrum), | Move first lateral clones to |
| | 29° C., 65% relative humidity | short day environment when 5 |
| | Night: 12 hour dark, 19° C., 70% relative humidity | new nodes are identified above |
| | | the first node on the clone. |
| 84-91 | Day: 12 hour light (1000 μmol/m² full spectrum), | Move second lateral clones to |
| | 29° C., 65% relative humidity | short day environment when 5 |
| | Night: 12 hour dark, 19° C., 70% relative humidity | new nodes are identified above |
| | | the first node on the clone. |
| 70-105 | Day: 18 hour light (1000 μmol/m² full spectrum), | Move clones to long day |
| | 29° C., 65% relative humidity | environment after 14 days of |
| | Night: 6 hour dark, 19° C., 70% relative humidity | short day treatment (earliest: |
| | | day 70 for apical clones, day |
| | | 84 for first lateral clones, day |
| | | 98 for second lateral clones) |
| 70-154 | Day: 18 hour light (1000 μmol/m² full spectrum), | Maintain plants in long day |
| | 29° C., 65% relative humidity | environment (6 plants per |
| | Night: 6 hour dark, 19° C., 70% relative humidity | grow bench, well fertigated) |
| 155 | Day: 18 hour light (1000 μmol/m² full spectrum), | Cut plant stem at plant base on |
| | 29° C., 65% relative humidity | each of the apical, first lateral, |
| | Night: 6 hour dark, 19° C., 70% relative humidity | and second lateral clones. |
| 158 | N/A | Place cut plant stems in heated |
| | | dry-down room |
| 160 | N/A | Harvest seeds from dried cut |
| | | plant stems with thresher. |

Prior to testing the Base Protocol, researchers used the following predictive equation to estimate potential seed yield:

$$Target Seeds = ( B ) \times ( T ) \times ( R ) \times ( Y )$$

B=the number of branches on a soy plant that can produce seeds per week
T=the number of weeks in the experiment
R=survival rate of the plant
Y=the seeds per plant

Applicant hoped to produce 10,000 seeds with the following target values:
B=7 branches per week
T=3 weeks
R=0.86 survival rate
Y=550 seeds/plant

$$10000 seeds = ( 7 branches / week ) \times ( 3 weeks ) \times ( 0.86 survival rate ) \times 550 ( seeds / plant )$$

Although Applicant did not achieve the estimated potential number of seeds determined by the equation using the Base Protocol, Applicant concluded that rooting success was a key factor in selecting which clones to keep to achieve more desirable seed counts. Due to limitation in physical space, especially in a controlled growing environment (75), Applicant was required to select fewer than the total number of available clones to propagate. Initial observations of rooting success following transplantation aided Applicant in selecting the best candidate clones capable of yielding higher seed counts in the future.

Applicant compared four varieties of soy from four maturity groups to determine which varieties responded favorably to the Base Protocol. Table 2 provides findings from Applicant's initial investigation into factors that dictate success using the Base Protocol. As Table 2 discloses, initial rooting success is a critical consideration to achieve larger-than-average seed count, because rooting success ultimately limited the number of clones that survived transplantation. Rooting success is generally defined as a cutting from a plant having roots two weeks after transplantation. Initial rooting success is generally measured as the number of clones which rooted divided by the total number of clones taken from the mother plant.

TABLE 2

| Maturity | | Branches/ | | | Rooting |
|---|---|---|---|---|---|
| Group | Variety | Week | Weeks | Clones | Success |
| 1.6 | 1 | 3.3 | 3 | 10 | .57 |
| 2.3 | 2 | 1.7 | 3 | 5 | .64 |
| 3.5 | 3 | 4.0 | 3 | 12 | .26 |
| 4.2 | 4 | 4.7 | 3 | 14 | .56 |

Applicant made the following observations based on the foregoing experiment with soy plants. First, multiple cuttings induce additional branching. Second, some varieties have superior rooting and branching abilities. Third, higher light intensity can produce additional clones. Fourth, the timing of the first cut was highly impactful. Fifth, rooting success also depended on the size of the clone cuttings, multi-node cuttings, and the acclimation settings. Sixth, the yield per plant depended on the variety and size of clones.

Applicant also observed that several key decision points required Applicant to make a judgement about which clones to take from the mother plant, which clones were likely to survive, and when to take a first lateral or second lateral clone. Applicant concluded that first and second lateral clones are most likely to survive when there is no wilting and/or browning observed on the clone and that initial rooting success is key for clone survival rates. Further, flowering time will control when apical and lateral clones should be taken: the later a plant flowers, the later clones should be taken, and vice versa.

### Example 2—Confirming Base Protocol Across Varieties

In Example 2, Applicant compared the performance of two soy varieties from maturity group 3.5 under the Base Protocol. In Example 2, researchers used the target seed equation from Example 1, and hoped to produce 10,000 seeds:

$$Target Seeds = ( B ) \times ( T ) \times ( R ) \times ( Y )$$

Due to physical space limitations, Applicant was unable to grow the maximum number of clones. Therefore, Applicant estimated total seed count based on the average number of seeds actually produced per plant actually grown multiplied by the total number of clones (i.e., both actual and potential clones (i.e., viable clones that formed from the mother plant, but were not kept solely due to the physical space limitations). Importantly, Applicant determined that later generations of clones were smaller plants and produced fewer seeds. However, clones that were taken later in this Example produced seeds quicker than clones taken earlier in this Example. The result was that regardless of when a clone was taken from the mother plant, all resulting plants produced seeds at approximately the same time, with older clones producing more seeds more slowly, and newer clones producing fewer seeds but relatively more quickly than the older clones.

Applicant concluded that there was no significant difference in the number of seeds produced between the two soy varieties tested. Rather, Applicant concluded from this Example that individual plant/clone vitality had a more significant impact on seed count.

Because not all plants/clones could be propagated due to space limitations, Applicant determined that individual choices about which plants to propagate and which to discard is a critical factor in producing a larger-than-average seed count. Building off findings in Example 1, Applicant determined that initial rooting success following transplantation as well as monitoring the plants for any signs of wilting or illness allowed Applicant to select the best candidate plants to be cloned where space was constrained.

Following Example 2, Applicant concluded that using the Base Protocol, it is possible to obtain approximately 30 clones that produce seeds, however, due to space limitations, the Base Protocol may not be cost effective in a growth chamber.

### Example 3—Base Protocol Applied to Maturity Groups

Applicant investigated four varieties of soy from four maturity groups to monitor effects of maturity groups on seed yield using the Base Protocol. Two mother plants from each variety were subjected to the Base Protocol yielding a total of 53 clones (total plants n=61, including mothers and clones).

Applicant concluded that higher maturity groups had the highest potential for clone production and seed count.

TABLE 3

| | Maturity | Average First | Average Second | Average |
|---|---|---|---|---|
| Variety | Group | Lateral Clones | Lateral Clones | Seed Count |
| 1 | 2.3 | 4 | 8 | 62 |
| 2 | 4.2 | 6.5 | 10.5 | 113 |
| 3 | 1.6 | 6 | 8.5 | 94 |
| 4 | 4.6 | 6.5 | 11 | 133 |

### Example 4-Seed Count Across Varieties

Applicant investigated the response of three varieties, across 2 maturity groups grown under Base Protocol conditions. Unlike Example 2, Example 4 primarily took place in a greenhouse, where costs were lower than in the growing chamber, but where there was less control over environmental conditions. However, Applicant used a reach-in chamber for short-day induction. Applicant also utilized smaller 3.5 inch pots instead of 1 gallon/6.5 inch pots due to space constrains in the greenhouse. Additionally, due to space restrictions in the greenhouse, researchers were not able to take second clones from mother plants.

Results from Example 4 are set forth in Tables 4-5.

TABLE 4

| | Variety | Variety | Variety |
|---|---|---|---|
| | 1 | 2 | 3 |
| Maturity Group | 2.3 | 3.5 | 3.1 |
| Average Number of Clones Per Mother Plant | 10 | 20 | 24.5 |
| Average Total Seeds per Source (Mother | 461 | 1107 | 1318.5 |
| Plant + All Clones) | | | |
| Average Seed per Mother Plant | 420 | 1136 | 943 |
| Average Seed per Apical Clone | 31 | 149 | 128 |
| Average Seed per Lateral Clone | 11 | 36 | 36 |
| Lateral Clones Taken | 18 | 15 | 18 |
| Lateral Clones Survived | 14 | 14 | 18 |
| Lateral Survival Rate (Lateral Clones | 0.78 | 0.93 | 1.0 |
| Survived/Lateral Clones Taken) | | | |

TABLE 5

| | | | | | Average |
|---|---|---|---|---|---|
| | | Average | Average | Average | Lifespan - |
| | | Lifespan - | Lifespan - | Lifespan - | First Lateral |
| | Maturity | All | Mother | Apical | Clone |
| Variety | Group | (Days) | (Days) | (Days) | (Days) |
| 1 | 2.3 | 81.53 | 106 | 91 | 77 |
| 2 | 3.5 | 92.65 | n/a | 105 | 91 |
| 3 | 3.1 | 92.4 | n/a | 105 | 91 |

Table 4 provides data regarding average clone production across the three varieties of soy. Variety 3 produced the most clones, followed by Variety 2, and Variety 1. Table 4 further discloses average seed production for the three varieties of soy. Variety 3 produced an average of 1318.5 seeds, Variety 2 produced an average of 1107 seeds, and Variety 1 produced an average of 463 seeds. Table 4 further discloses the survival rates for the three varieties of soy. Variety 3 had 100% of lateral clones survive, Variety 2 had 93% of lateral clones survive, and Variety 1 had 78% of lateral clones survive.

Table 5 discloses average life spans for three varieties of soy. Variety 3 had an average lifespan of 92.4 days, Variety 2 had an average 92.65 day lifespan, and Variety 1 had an average 81.53 day lifespan.

Example 4 allowed Applicant to complete the Base Protocol for soy in approximately 130 days for Variety 2 and Variety 3 of soy.

Based on this Example 4, Applicant concluded that certain varieties were better candidates for the Base Protocol. This Example 4 suggests that the Base Protocol would be sufficiently effective in a greenhouse, however it was less preferred than conducting the Base Protocol in an indoor growing chamber because of the decreased ability to control environmental conditions. Further, Example 4 demonstrated that the Base Protocol is better suited for particular varieties of soy in Maturity Group 3. Applicant observed from this Example that 3.5 inch pots were less preferred, and are believed to have limited plant growth. Space restrictions in the greenhouse prevented use of 1-gallon pots. Applicant hypothesizes that a 4.5 inch pot would be preferred to a 3.5 pot, but would still allow significant space saving as comparted to a 1-gallon pot.

### Example 5—Base Protocol Confirmation

Applicant utilized the Base Protocol as informed by the findings of Examples 2-4 to test three groups of one variety of soy from maturity group 3.5. Applicant grew soy plants from three test groups, with two mother plants from each test group (n=118 total plants, including clones and mother plants) in 6.5 inch pots in accordance with the Base Protocol. Findings are set forth in Tables 6 and Table 7.

TABLE 6

| | | Average | Average | Total | Total | Average |
|---|---|---|---|---|---|---|
| Test | Maturity | Taken | Potential | Clones | Potential | Seed |
| Group | Group | Clones | Clones | Taken | Clones | Count |
| 1 | 3.5 | 23 | 25.5 | 46 | 51 | 372.15 |
| 2 | 3.5 | 17 | 23.5 | 34 | 47 | 367.72 |
| 3 | 3.5 | 14 | 20.5 | 28 | 41 | 352.42 |

TABLE 7

| Test | Maturity | Mother | Total | Total Seed minus 10% |
|---|---|---|---|---|
| Group | Group | Plant | Seed | (average bad seed) |
| 1 | 3.5 | A | 9111 | 8209 |
| 1 | 3.5 | B | 8380 | 7550 |
| 2 | 3.5 | A | 6600 | 5947 |
| 2 | 3.5 | B | 6638 | 5981 |
| 3 | 3.5 | A | 4898 | 4413 |
| 3 | 3.5 | B | 4755 | 4284 |

As Tables 6 and 7 disclose, Applicant was able to obtain higher-than-average yield of seed from a single mother plant. While Test Groups 1 and 2 yielded more seed than Test Group 3, the difference was not statistically significant. Nor did Applicant observe any statistically significant differences in seed yield based on plant type (i.e. mother, first lateral, second lateral, or apical clone). Applicant observed that clones in this Example taken later tended to finish producing seeds faster. On average, plants produced 361 seeds per plant, and an average of 24 plants (including clones and mother plant) produced seeds. However, in this Example, some seeds produced were unusable and had to be removed from the final seed count. (Because Applicant counted seeds from this Example on a single day, many of the newer clones' seeds were underdeveloped and unlikely to be viable if planted.) Applicant observed approximately 10% of seeds were likely non-viable.

TABLE 8

| | | | Non- | Non- | Non- |
|---|---|---|---|---|---|
| | Total | Non- | viable | viable | viable |
| | non- | viable | seed from | seed from | seed from |
| Test | viable | seed from | first | second | apical |
| Group | seed | Mother | clones | clones | clones |
| 1 | 12.8% | n/a | 23.3% | 10.3% | 4.4% |
| 2 | 7.5% | 3.54% | 3.09% | 11.9% | 5.83% |
| 3 | 9.13% | n/a | n/a | 10.60% | 1.81% |

Applicant observed that the lifespan of each successive clone was shorter, with the mother plant's lifespan being the longest, and the second lateral clone's being the shortest. Applicant did not observe any significant difference in the average number of seeds produced by successive clones. Mother plants' lifespan on average was approximately 160 days, apical clones' lifespan on average was approximately 135 days, first lateral clones' lifespans on average were approximately 130 days, and second lateral clones' lifespans were on average approximately 120 days. Applicant used these approximate lifespans to determine when to begin the Base Protocol for each successive clone. For example, these results suggest that the apical clone should be cut on day 25 (viz. Day 160-Day 135) so that seed from the apical clone can be harvested on the same day as the seeds harvested from the mother plant.

### Example 6—Yellow Pea

The same protocol described in Example 1 for soybeans was utilized with yellow pea, however because yellow pea is photoperiod insensitive, no short-day light treatment was used. A single yellow pea plant is able to produce fewer clones and fewer seeds per clone as a final output when compared with soybeans. Further, because yellow pea plants flower at a different interval than soy, Applicant generally looked to the flowering date of each yellow pea plant to determine when clones should be taken (i.e., a later flowering date correlated with a later clone cutting date and vice versa). Applicant also observed health metrics of the yellow pea plants (e.g. rooting success, wilting, browning, and/or flowering) before transplantation as well as 3-5 days following transplantation to determine which individual plants were likely to survive.

In this Example, Applicant was able to obtain more than approximately 400-600 seeds per yellow pea plant. This Example suggests that a single yellow pea plant will commonly be capable of producing 6-10 clones and 2000-4000 total seeds from a single mother yellow pea plant.

In this Example, Applicant sought to determine whether yellow pea can be cloned using the Base Protocol, whether differences among yellow pea plant varieties is observable, and whether temperature differences in the Base Protocol yield different results for yellow pea seed counts. In particular, Applicant grew seven varieties of yellow pea in two environments: a warm room with daytime temperatures at 29° C. and a cool room with daytime temperatures at 23° C. In all other aspects, the Base Protocol as informed by Examples 1-5 was utilized.

Applicant predicted approximately 700 seeds per yellow pea plant would be produced using the Base Protocol. In this Example, Applicant observed approximately 43% more seeds were produced than predicted, as disclosed in Table 9.

TABLE 9

| | Mother Plant | Apical | First Lateral | Second Lateral |
|---|---|---|---|---|
| Predicted Results | 270.3 | 192.3 | 142.9 | 75.8 |
| Actual Results | 297.5 | 222.9 | 210.9 | 152.5 |

Table 10 discloses number of surviving yellow pea plant clones, and Table 11 disclosed rooting success. Applicant found approximately 50% of all clones successfully rooted (i.e. 63% successfully rooted in warm conditions, and 36% in cool conditions), and 68 clones survived (48 in warm conditions, and 36 in cool conditions, an average of 7 potential clones per warm plant, and an average of 5 potential clone per cool plant). As already noted above, successful rooting is generally determined by comparing the number of clones with roots approximately two weeks after transplantation divided by the total number of clones taken.

TABLE 10

| | Average | | | | |
|---|---|---|---|---|---|
| | Number | Total | | Number | Number |
| | of Clones | Number | Number | of First | of Second |
| | Survived | of Clones | of Apical | Lateral | Lateral |
| | per Source | Survived | Survived | Survived | Survived |
| Warm | 7 | 48 | 10 | 15 | 23 |
| Conditions | | | | | |
| Cool | 5 | 20 | 0 | 0 | 20 |
| Conditions | | | | | |

TABLE 11

| | Rooting | Apical | First Lateral | Second Lateral |
|---|---|---|---|---|
| | Success | Success | Success | Success |
| Warm Conditions | 63% | 45.83% | 79.17% | 64.58% |
| Cool Conditions | 36% | 0% | 41.67% | 64.58% |

Tables 12 and 13 disclose seed count data for yellow pea grown in warm versus cool conditions. Many of the cool-grown yellow pea clones were discarded due to space limitations. Applicant compared results for eight varieties of yellow pea grown in warm versus cool conditions to determine whether any particular varieties produce a statistically different number of seeds when grown in warm vs cool conditions.

TABLE 12

| | | | Average | Average | |
|---|---|---|---|---|---|
| | | Average | Seed per | Seed per | |
| | Average | Seed per | First | Second | Average |
| | Seed per | Apical | Lateral | Lateral | Clones per |
| | Mother | Clone | Clone | Clone | Mother |
| Warm | 291.5 | 222.9 | 210.9 | 152.5 | 7.2 |
| Conditions | | | | | |
| Cool | 299 | n/a | n/a | 38.4 | 5.54 |
| Conditions | | | | | |

TABLE 13

| | Average | Statistically Significant |
|---|---|---|
| | Seed Count | Difference Between Warm and Cool |
| Variety 1 - Warm | 294.3 | No |
| Variety 1 - Cool | 301.7 | |
| Variety 2 - Warm | 222.3 | Yes |
| Variety 2 - Cool | 266.7 | |
| Variety 3 - Warm | 198.3 | Yes |
| Variety 3 - Cool | 236.3 | |
| Variety 4 - Warm | 338.3 | No |
| Variety 4 - Cool | 368.0 | |
| Variety 5 - Warm | 334 | No |
| Variety 5 - Cool | 268.7 | |
| Variety 6 - Warm | 352 | No |
| Variety 6 - Cool | 281 | |
| Variety 7 - Warm | 284.7 | No |
| Variety 7 - Cool | 331 | |
| Variety 8 - Warm | 308 | No |
| Variety 8 - Cool | 338.7 | |

Applicant observed two varieties of yellow pea plants which produced statistically significant different amounts of seed when grown in warm vs cool conditions. In each case, varieties exposed to cool conditions produced a higher number of seeds.

Tables 10-13 suggest that warm conditions may be beneficial to yellow pea during initial rooting following clone transplantation, but that cool conditions following rooting will yield the highest number of seeds for some varieties of yellow pea plant.

### Example 7—Base Protocol for Additional Soy Variety

Applicant repeated the Base Protocol for an additional variety of soy. A total of 16 mother plants of the same variety from maturity group 4.2 were grown in 6.5-inch pots. A total of 432 soy plants (including mother plants and clones) were observed for this Example. Results confirmed the Base Protocol as Table 14 discloses.

TABLE 14

| Mother Plant | Total Clones Taken |
|---|---|
| A | 16 |
| B | 36 |
| C | 39 |
| D | 14 |
| E | 39 |
| F | 10 |
| G | 27 |
| H | 36 |
| I | 17 |
| J | 17 |
| K | 38 |
| L | 39 |
| M | 22 |
| N | 37 |
| O | 14 |
| P | 14 |

Although research is ongoing, Example 7 suggests this variety of soy may reasonably be expected to yield between approximately 10,000-20,000 seeds and each mother plant may be capable of producing up to approximately 40 clones.

### Example 8—Other Species

In another example, species other than soybean and yellow pea were asexually propagated using the Base Protocol. In particular, Applicant initiated the Base Protocol for chickpea (Cicer arietinum), mung bean (Vigna radiata), and tomato plants (Solanum lycopersicum) with the results disclosed in Table 15.

TABLE 15

| | Mother | Total | Average Clones per |
|---|---|---|---|
| Species | Plants | Clones | Mother Plant |
| Chickpea | 3 | 45 | 15 |
| Mung Bean | 3 | 29 | 9.7 |
| Tomato | 3 | 43 | 14.3 |

As Table 15 suggests, the Base Protocol can be utilized to grow additional clones from a single mother plant for other plant species, especially the three chosen for the Example. Chickpea produced the most clones/mother plant and mung bean produced the fewest. Applicant did not collect seed from these plant species, but anticipates that this protocol would yield a higher-than-average number of seeds for these plants, and other plants subjected to the Base Protocol. Thus, this Example suggests that the Base Protocol can be used to propagate clones and produce larger-than-average amounts of seed for other plant species, including other legumes. To produce a higher-than-average number of seeds in photoperiod sensitive plants or legume varieties, a short-day induction step would be included in the Base Protocol. To produce a higher-than-average number of seeds in photoperiod insensitive legume varieties, no short-day induction would be included.

While particular embodiments of the present invention have been shown and described, it should be noted that changes and modifications may be made without departing from the presently disclosed inventive concepts in its broader aspects and, therefore, the aim in the appended claims is to cover all such changes and modifications as fall within the true spirit and scope of this invention.

For example, the teachings herein are not limited to certain plant species, and it is envisioned that they can be modified to be useful for monocots, dicots, and/or substantially any crop and/or valuable plant type, including plants that can reproduce by self-fertilization and/or cross fertilization, hybrids, inbreds, varieties, and/or cultivars thereof. Some of example plant species include, soybeans (Glycine max), peas (Pisum sativum and other members of the Fabaceae like (janus and Vigna species), chickpeas (Cicer arietinum), peanuts (Arachis hypogaea), lentils (Lens culinaris or Lens esculenta), lupins (various Lupinus species), mesquite (various Proopis species), clover (various Trifolium species), carob (Ceratonia siliqua), tamarind, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), camelina (Camelina sativa), millet (e.g., pearl millet (Pennisetum glaucum), proso millet (Panicum miliaceum), foxtail millet (Setaria italica), finger millet (Eleusine coracana)), sunflower (Helianthus annuus), quinoa (Chenopodium quinoa), chicory (Cichorium intybus), tomato (Solanum lycopersicum), lettuce (Lactuca sativa), safflower (Carthamus tinctorius), wheat (Triticum aestivum), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oil palm (Elaeis guineensis), poplar (Populus spp.), eucalyptus (Eucalyptus spp.), oats (Avena sativa), barley (Hordeum vulgare), flax (Linum usitatissimum), Buckwheat (Fagopyrum esculentum) vegetables, ornamentals, and conifers.

What is claimed is:

1. A method to produce seeds from a single mother plant having an apical meristem, wherein the single mother plant is in one or both of a vegetative state and reproductive state, the vegetative state having vegetative stages and the reproductive state having reproductive stages, the method comprising:
(a) growing the mother plant under conditions designed to substantially maintain the mother plant in a vegetative state and substantially delay reaching reproductive stage;
(b) removing the apical meristem from the mother plant once the mother plant has reached a desired stage of growth;
(c) removing one or more branches from the mother plant as one or more branch cuttings wherein the one or more branches were sufficiently developed on the mother plant following the removal of the apical meristem;
(d) maintaining each of the one or more branch cuttings in growth media under acclimation conditions until each of the branch cuttings resume growing vegetatively as clone plants;
(e) inducing the clone plants to flower;
(f) once the clone plants have been induced to flower, returning the clone plants to vegetative growth conditions; and
(g) maintaining the clone plants under vegetative growth conditions until they have produced a desired number of seeds.

2. The method of claim 1 wherein the mother plant is a short-day plant, the conditions to substantially maintain the mother plant in a vegetative state and substantially delay reaching reproductive stage comprising applying long-day conditions to the mother plant.

3. The method of claim 1 wherein the desired level of growth is determined by assessing at least one of the vegetative and reproductive stages of the mother plant to determine whether the mother plant has progressed enough to remove the apical meristem.

4. The method of claim 1 further comprising exposing each of the one or more branch cuttings to an auxin solution before maintaining the branch cuttings in the growth media.

5. The method of claim 4 wherein exposing is selected from the group comprising applying the auxin solution to the branch cutting by brushing on, dripping on, pouring on, or spraying on and placing the branch cutting in a container with the auxin solution.

6. The method of claim 5 wherein the auxin solution includes auxin, nutrients, and pH balanced water solution

7. The method of claim 1 wherein maintaining the branch cuttings in growth media under acclimation conditions until the branch cutting resumes growing vegetatively further comprises exposing the branch cuttings to high relative humidity and vegetative growing conditions.

8. The method of claim 1 further comprises exposing the growth media to an auxin solution prior to receiving the branch cuttings therein.

9. The method of claim 1 further comprises maintaining the apical meristem cutting in a growth media under acclimation conditions until the apical meristem cutting begins growing vegetatively.

10. The method of claim 9 further comprises exposing the apical meristem cutting to an auxin solution.

11. The method of claim 10 wherein maintaining the apical meristem cutting in growth media under acclimation conditions until the apical meristem cutting resumes growing vegetatively further comprises exposing the apical meristem cutting to high relative humidity and vegetative growing conditions.
